(19) United States
(12) Patent Application Publication
(10) Pub. No.: US 2014/0180848 A1
(43) Pub. Date: Jun. 26, 2014

(54) Estimating Point Of Sale Wait Times

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/722,984

(22) Filed: Dec. 20, 2012

(51) Int. Cl. G06Q 20/20

(52) U.S. Cl. CPC G06Q 20/20
USPC 705/16; 705/26.1

(57) ABSTRACT

Systems and methods are disclosed herein for providing an estimate of the delay to check out at a store for a target time and date. A user computing device may receive or infer target data such as a time, date, and location at which a user would like to go shopping. The target data may then be input to a delay model for a target location. The delay model returns a checkout delay estimate that is provided to a requesting user. In some embodiment, alternate locations to a target location that provide a shorter wait time may be identified. In some embodiments, delay estimates may be based on throughput data for cashiers working at a target time. The delay model may be trained or updated using observations of wait times based on images of a queue at a POS station.

### BACKGROUND

1. Field Of The Invention

This invention relates to systems and methods processing transaction at an in-store point of sale (POS).

2. Background Of The Invention

Shopping is a regular task but can often be frustrating. There are many sources for frustration and delay. However, the aspect of shopping that is most consistently inconvenient is time spent at a point of sale (POS) waiting to check out. A shopper that hopes to make a quick trip to the store may spent an unreasonable time waiting in line at a POS. Often a shopper may have many options when to go shopping but may make the unfortunate choice to go shopping at a busy time. Events and holidays can lead to unpredictable busy times that can be hard to anticipate.

This problem can be particularly difficult for a successful store chain. A store chain may spend a great deal of time cultivating good will and advertising products and prices. When successful, this effort and expense can bring a large number of customers. The expense and effort may then be wasted, as these customers are irritated and frustrated by unexpected and unacceptable delays in checking out.

The systems and methods disclosed herein provide an improved approach for enabling customers to avoid delays on checkout.

### BRIEF DESCRIPTION OF THE DRAWINGS

In order that the advantages of the invention will be readily understood, a more particular description of the invention will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a system for performing methods in accordance with embodiments of the invention;

FIG. 2 is a block diagram of a computing device suitable for implementing embodiments of the invention;

FIG. 3 is a schematic diagram of a POS station in which methods in accordance with the invention may be implemented;

FIG. 4A is an example interface for obtaining delay predictions in accordance with an embodiment of the invention;

FIG. 4B is an alternative interface for obtaining delay predictions in accordance with an embodiment of the invention;

FIG. 5 is a process flow diagram of a method for generating a delay model in accordance with an embodiment of the invention;

FIG. 6 is a process flow diagram of an alternative method for generating a delay model in accordance with an embodiment of the invention;

FIG. 7 is a process flow diagram of a method for obtaining delay predictions in accordance with an embodiment of the invention;

FIG. 8 is a process flow diagram of a method for providing delay predictions in accordance with an embodiment of the invention;

FIG. 9 is a process flow diagram of a method for characterizing cashier performance in accordance with an embodiment of the invention; and

FIG. 10 is a process flow diagram of a method for providing delay predictions using cashier performance in accordance with an embodiment of the invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

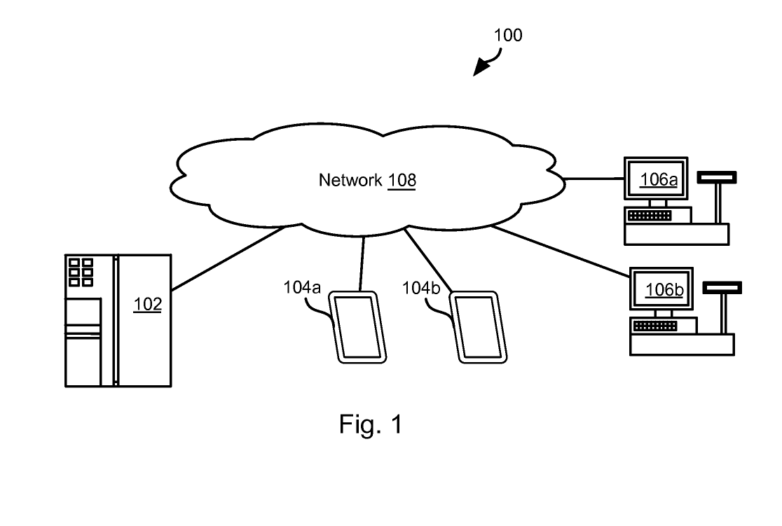

FIG. 1 illustrates a system 100 in which methods described hereinbelow may be implemented. The system 100 may include a server system 102 that may be embodied as one or more server computers each including one or more processors that are in data communication with one another. The server system 102 may be in data communication with one or more user computers 104a, 104b and one or more point of sale (POS) devices 106a, 106b. In the methods disclosed herein, the user computers 104a, 104b are advantageously mobile devices such as a mobile phone or tablet computer. In some embodiments, some or all of the methods disclosed herein may be performed using a desktop computer or any other computing device as the user computer 104a, 104b. For purposes of this disclosure, discussion of communication with a user or entity or activity performed by the user or entity may be interpreted as communication with a computer 104a, 104b associated with the user or entity or activity taking place on a computer associated with the user or entity. A POS 106a-106b may be located within a store and may be part of a POS network. In some embodiments, a POS 106a, 106b may be operable to process online transactions. In some embodiments, separate computers of the server system 102 may handle communication with the user computers 104a, 104b and POS 106a, 106b.

Some or all of the server 102, user devices 104a, 104b, and POS 106 may communicate with one another by means of a network 108. The network 108 may be embodied as a peer-to-peer wireless connection between devices, a connection through a local area network (LAN), WiFi network, the Internet, or any other communication medium or system.

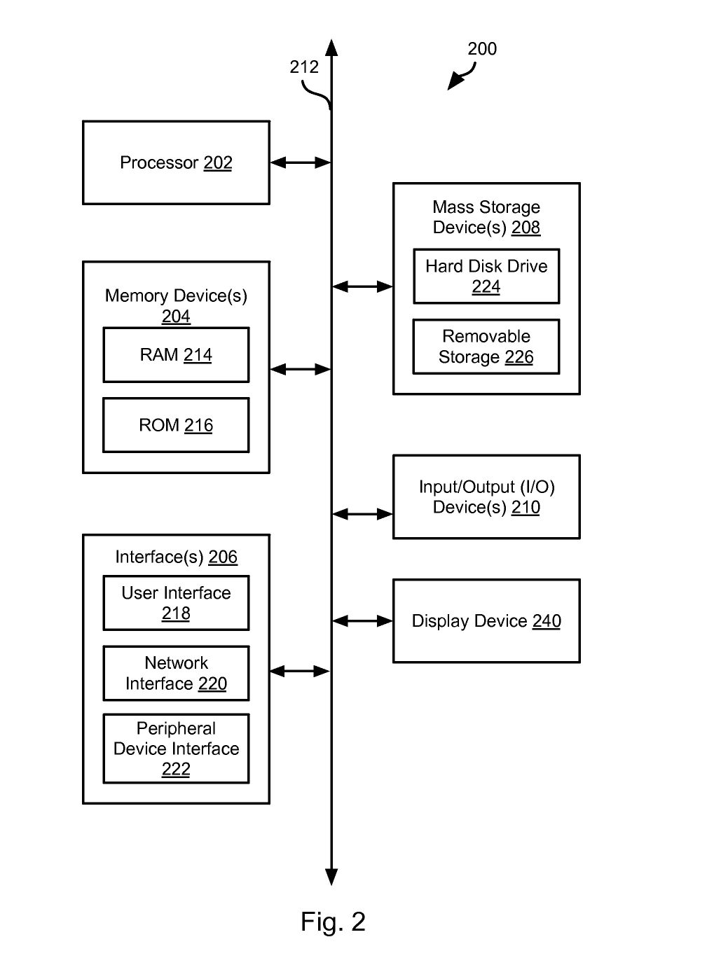

FIG. 2 is a block diagram illustrating an example computing device 200. Computing device 200 may be used to perform various procedures, such as those discussed herein. A control module 100 and cart control module 124 may include some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

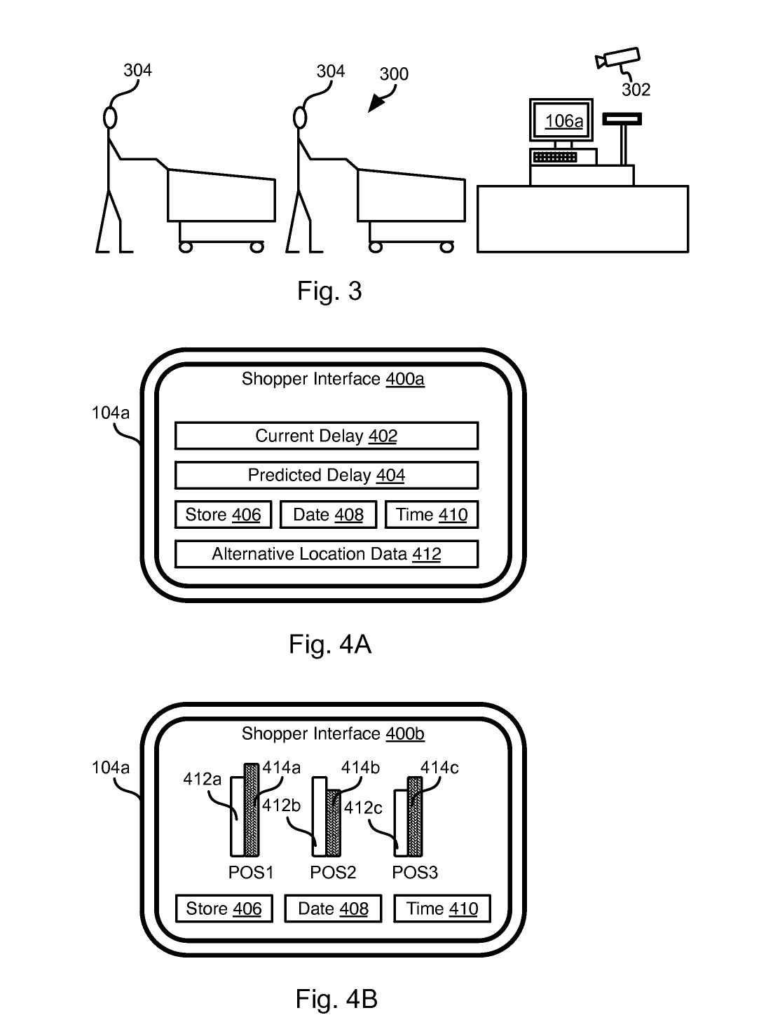

FIG. 3 illustrates POS station 300 such as may be present at any store. The system 300 may include a POS 106a and a camera 302 positioned and oriented to view customers 304 in a queue to checkout. The camera 302 may preferably provide a video, or periodic still image, output of sufficient resolution to enable distinguishing of the presence of customers 304 in a queue for the queue station 300. In particular, the output of the camera 302 may be sufficient to enable counting of the number of customers but need not have sufficient resolution to, for example, resolve facial features and identify a particular customer. The camera 302 may be a camera used as a security camera with video or still image data provided to an employee or service providing security for the store. In some embodiments, the camera 302 may be embodied as an infrared camera providing an output in which the thermal signature of humans is more readily discernible.

FIG. 4A illustrates an example interface 400a for display on a user computing device 104a. The interface 400a may display a prediction of wait times for a time or location. Display of the interface 400a may be invoked by user interaction with a user interface element in another interface of an application provided by a merchant. Alternatively, the interface 400a may be a stand-alone application that invokes display of the interface 400a upon input by a user of one or more of a date, time, and location. In some embodiments, logic invoked by the interface 400a may access a location of the user computing device 104a, 104b such as by means of a global positioning system (GPS) receiver hosted by the user computing device 104a, 104b or inferring a device location based on IP address, cell phone tower location, or the like. The location used in accordance with methods disclosed herein may be a store location, such as a store location selected by a user or a store location that is chosen by default to be that which is closest to the inferred current location of a user. Likewise, the date for which a prediction is desired may be inferred by default to be the current date as reflected by an operating system of the user computing device 104a, 104b.

The interface 400a may include one or both of an interface element 402 indicating the current delay to checkout at a specified or inferred location and an interface element 404 indicating a predicted delay at a specified time at an inferred or specified location and an inferred or specified date. For purpose of this disclosure a delay and a delay estimate indicate a wait time for a customer to checkout at a POS station 300. In some embodiments, the interface 400a may additionally display location 406 of a specified or inferred store, a target date 408, and a target time 410. In some embodiments, elements 406-410 of the interface 400a are fields that accept input values and continue to display them.

In some embodiments, the interface 400a may include alternative location data 412. Alternative location data 412 may provide information regarding alternative locations that are close to one or both of the user's current location or a specified store location. The alternative location data 412 may include one or both of a current delay and a predicted delay at a target date and time for one or more alternative location. The alternative location data 412 may additionally or alternatively include a distance or travel time to one or more alternative locations. Alternatively or additionally, the alternative location data 412 may indicate an improvement in time spent taking into account additional travel time and differences in expected wait time between a target location and an alternative location.

FIG. 4B illustrates an alternative interface 400b. In some embodiments, a user may be able to choose between either of the interfaces 400a, 400b or customize either interface to include some or all of the elements in either of the interfaces 400a, 400b. The interface 400b may include the like-numbered elements shown in FIGS. 4A and 4B and may additionally include a plurality of indicators 412a-412c of current wait times at individual points of sale at a target location, date, and time and/or a plurality of indicators 414a-414c of predicted wait times for the target location, date, and time. The indicators 412a-412c, 414a-414c may include any representation of wait time in a textual or graphical manner, such as a bar graph, a number of dots or other icons indicating a number of people in line at a POS, a numerical representation of a delay estimate, or the like.

In some embodiments, the estimates for different POS stations may be calculated and presented, along with a type label, for different types of POS stations, either on demand or as a combined display. For example, delay estimates may be provided for POS station types including an assisted lane, an express lane (e.g. N items or less, a lane with restricted items (e.g. alcohol, cigarettes, etc.), a self-check out lane, mobile self-checkout lane, pharmacy line, photo development service, banking service, or any other POS or service provided by a store. A POS type may be a POS type defined as having two or more of the above listed types, e.g. a assisted and restricted lane, assisted express lane, or other combination.

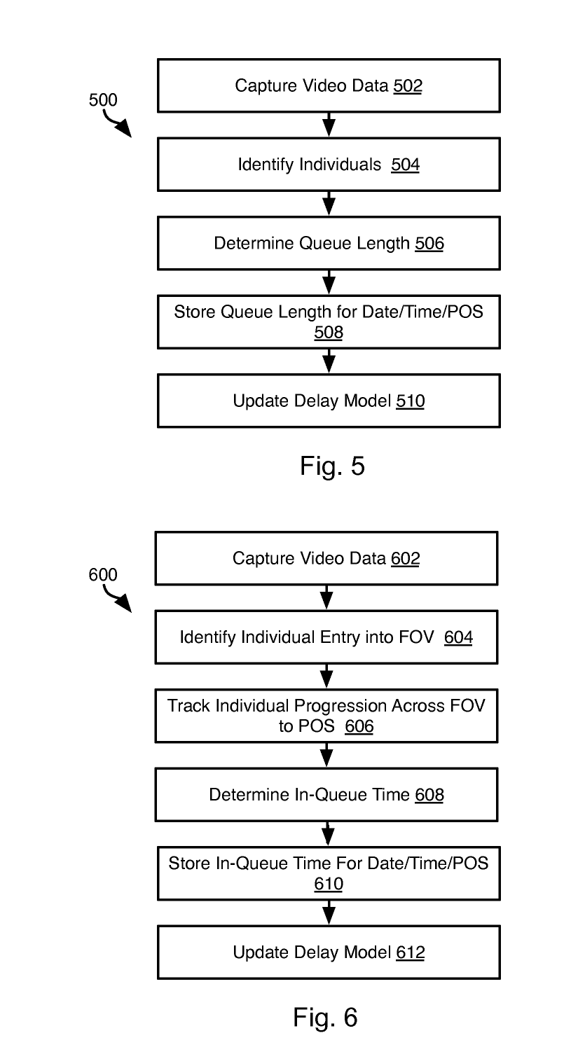

Referring to FIG. 5, predictions of wait times for location may be based on analysis of delay data gathered for a particular location at various dates and times. For example, the method 500 may include capturing 502 video data 502 from a plurality of cameras 302 each having in the field of view thereof POS stations 300 of a particular location, e.g. a store or stores in the same geographic area such as a neighborhood, city, county, or some other geographic area.

The method 500 may include analyzing the video data to identify individuals 504 in frames of the video data. All frames of video data may be analyzed or only a subset of all frames of the video data, e.g. every Nth frame. For a particular frame, the number of individuals identified 504 in the frame may be counted in order to determine 506 queue length. The determined 506 queue length may be stored 508 for later use in association with one or more of the date, time, and location when the analyzed frame was recorded. Alternatively or additionally, the queue length along with the corresponding date, time, and location may be used to update 510 a delay model for the location. In some embodiments, a delay model may be generated for a particular POS type using data gathered for that POS type, such as the POS types disclosed hereinabove. In such embodiments, a request for a delay estimate according to the methods described herein may specify the POS type for which a delay estimate is desired.

The delay model may be generated using any data modeling technique or machine learning model that takes as input training set of date that is embodied as mappings between a date, time, and location data point and a measured queue length for that data point. Accordingly, updating 510 the delay model for a queue length measurement may include adding the measurement along with the date, time, and location when the measurement was made to the training set. A delay model may then be trained or updated according to the training set such that the output of the delay model for a given data point will be a delay estimate. The delay model may further take as inputs for the training set or analyzed data other attributes of a data point a day of the week for the data point, whether the data point is a holiday and an identifier of the holiday, or any other descriptor of the circumstance in which the data point was measured.

FIG. 6 illustrates an alternative method 600 for generating or updating a delay model. The method 600 may include capturing video data 602 in the same manner as for the method 500. The frames of the video data may be analyzed to identify 604 individual entry into a field of view (FOV) of a particular camera output. The following frames of the camera output may be analyzed to track 606 progression of the individual across the FOV of the camera output until the identified 604 individual one or both of leaves the FOV of the camera output and leaves the queue, e.g. moves past a point in the FOV at which actual checkout occurs. The delay between the time corresponding to the frame identified 604 for the entry of the individual to the FOV or queue and the time that the individual leaves the queue or FOV may be determined 608 and used as a metric of the delay experienced by that user. The in queue time determined 608 for the individual may be stored 610 in combination with the date, time, and location at which the in-queue time was measured. Storing the in-queue time may additionally include storing other descriptors of the circumstance in which the in-queue time was measured, such as day of the week, whether the date was a holiday, or other descriptor of the circumstance.

In the same manner as for the method 500, the in-queue time and the circumstances in which the in-queue time was measured may be added to a training set used to train a delay model or otherwise used to train or update 612 a delay model according to any data modeling technique or machine learning algorithm known in the art.

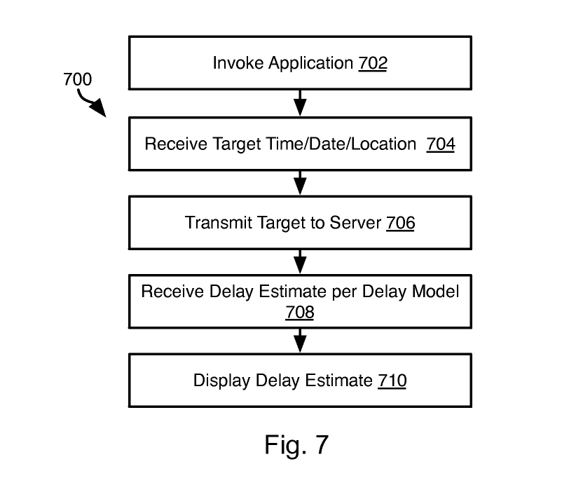

FIG. 7 illustrates a method 700 that may be executed on a user computing device 104a, 104b or executed elsewhere with an interface provided on the user computing device 104a, 104b. The method may include invoking 702 a merchant application or a web page provided by a merchant or some other entity with access to merchant data. Using the application or other interface, at least a target time can be received 704. A target date and location may also be received 704. In some embodiments, some or all of this information may be inferred. For example, the date may be inferred to be the current date, or a typical shopping date specified by a user or inferred from past user behavior. A location may be inferred to be a store operated by a merchant, or other participating merchant, that is closest to the current location of the user computing device 104a, 104b, as determined using a GPS receiver, IP address, adjacent cell phone tower locations, or other data. In some embodiments, even a time may be inferred to be a usual shopping time previously input by a user or observed from past behavior of the user. In some embodiments, a time may be inferred to be a time offset from the current time (e.g. the time when the method 700 is invoked or the time at some point in execution of the method 700). The offset may be equal to a sum of a drive time from the user's current location and an anticipated shopping time for a user or the particular user. The drive time may take into account available traffic data. In some embodiments a user may specify a shopping list for a shopping trip. In such embodiments, the amount of time that a user is expected to spend shopping when determining an anticipated shopping time may be based on the shopping list. For example, using a typical walking speed (or a known walking speed for the user), a layout of the closest store, and the shopping list, an expected or ideal route may be calculated and used to determine an estimated shopping time.

In instances where all of the date that might be received 704 is inferred the step of receiving 704 information may be omitted. In such instances, invocation of the application may invoke inferral and use of this information. In some embodiments, a user may input an instruction for the application to use inferred information rather than input information. In some embodiments, a user may input some information and information that is not provided may then be inferred.

Target information as provided be a user or inferred may be transmitted 706 to a server operated by a merchant or otherwise having access to delay data for a merchant, such as a server system 102. In some embodiments, an instruction to provide a delay estimate may be transmitted 706 without target information and the server system may infer the target information in the same manner as described above. In some embodiments, the instruction will include at least a location of the user computing device 104a, 104b transmitting the instruction inferred as described above. In some embodiments, the server system may have access to user data that is used to infer target data in the same manner as described above.

In response to receipt of the target information or instruction to provide a delay estimate, a server may input the target information or inferred target information to a delay mode. As already noted, the target information may include a date, time, location, or other information. The server system may retrieve other data corresponding to the target data to input to the delay model, such as a day of the week of the identified date, whether the target date is a holiday, or any other information that was used to train the delay model.

The server system may determine a predicted delay according to the delay model and return the predicted delay to the requesting user computing device 104a, 104b. The user computing device 104a, 104b may then receive 708 the delay estimate, and any other returned information, and display 710 the delay estimate to the user, such as according to one of the interfaces 400a, 400b.

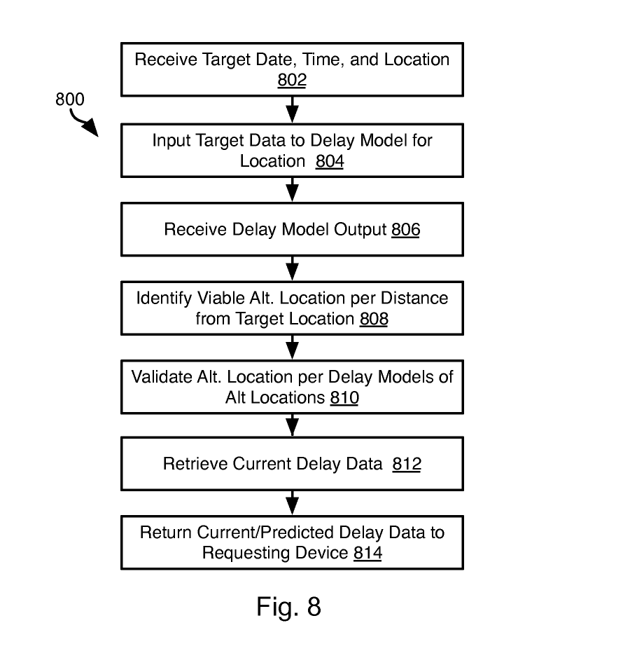

FIG. 8 illustrates a method 800 that may be invoked in response to a request for a delay estimate or in anticipation of request for a delay estimate. The method 800 may be executed by a server system operated by a merchant or with access to merchant delay data.

The method may include receiving 802 an instruction to provide a delay estimate including one or more of a target date, time, and location. As discussed above, some or all of this information may be inferred based on a current date and time and a current location of the user. As also mentioned above, inferring this information may include the use of information in a user account hosted by the server system or accessible by the server system.

The received or inferred target data may then be input 804 to a delay model for a target location or an inferred target location. The delay model may be a model as described hereinabove. The target data may be used to gather other data for input to the model, such as a day of the week, holiday, or other data describing the circumstances of the target data as receivable by the delay model.

The output of the delay model for the target data and any other circumstantial data may be received 806. In some embodiments, this may be the only processing performed according to the method 800 and this output may be returned to a requesting user computing device 104a, 104b.

In some embodiments, other information that may be relevant to a requesting user may also be calculated and returned. In some embodiments, a request for a delay estimate may request return of some of the additional information described below.

In some embodiments, alternative stores may be identified that might provide a quicker shopping trip for a customer. Accordingly, the method 800 may include identifying 808 one or more viable alternative locations according to the alternative location's distance from the location specified in a request, an inferred location based on a request, or from a store closest to a location of a user computing device generating a request. A viable alternative location may be one for which a drive time to and from the alternative location from one of the above mentioned locations is less than a delay estimate received 806 from the delay model for a closest store to the target location. In this manner, an alternative location that would clearly not result in any time savings will not be considered. The drive time estimate may take into account real time traffic data or historical traffic data.

The viable alternatives identified 808 may then be validated 810 according to the delay models for the viable alternatives. This may include computing a sum of the additional drive time for the alternative location and the delay estimate for the alternative location using the target data for the request. In some embodiments, the target time input to the delay model for an alternative location may be offset by the additional drive time required to reach the alternative location. Validating 810 may further include eliminating alternative locations for which the sum of the additional drive time to and from the alternative location and the delay estimate for the alternative location exceeds the delay estimate for the closest store location. Any alternative locations that remain may be returned to the requesting user along with such information as the additional drive time and the delay estimate for the validated alternative locations.

In some embodiments, the method 800 may further include retrieving 812 current delay data for one or both of the closest store location and any validated alternative locations. The current delay data may be determined using video data such as that using the methods for obtaining delay data for training a delay model as described with respect to FIGS. 5 and 6.

Data determined according to the method 800 may then be returned 814 to a requesting user or user computing device 104a, 104b. This data may include a delay estimate and/or current checkout delay for a closest store to a target location, a location of the closest store, locations of any validated alternative locations, the drive time or additional drive time to a validated alternative location, the estimated and/or current checkout delay for any validated alternative locations, or other information calculated as described above.

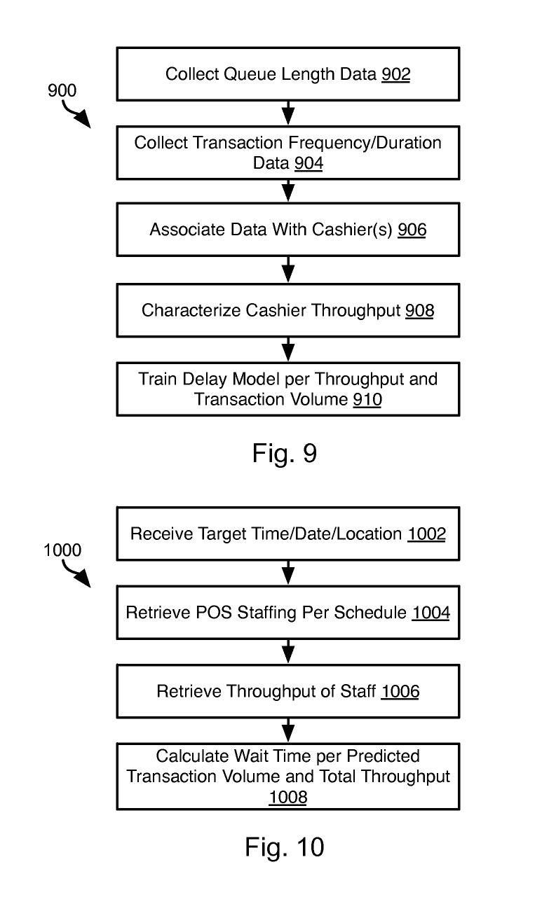

In many instances the experience level or expertise of a cashier can have a large impact on wait times. Accordingly, the method 900 of FIG. 9 may be used to gather and analyze data for providing estimates informed by throughput of actual cashiers that may be working at a store closest to a target location.

For example, the method 900 may include collecting data, such as collecting 902 queue length data with respect to date and time as described above and collecting 904 transaction frequency and/or duration data with respect to date and time. Transaction frequency refers to how many transactions are conducted per unit time at a particular store and transaction duration describes how long a transaction takes from when the transaction is initiated (e.g. a first item is scanned) and a transaction is concluded (e.g. payment is received or a receipt output for the transaction).

Some or all of the collected 902, 904 data may be associated with a particular user. For example, the times a cashier is working and the POS station 300 at which the cashier is working (such as as reported by a work schedule) may be used to identify transactions that were conducted at that POS station 300 during the time the cashier was working. In this manner, some or all of the queue lengths, transaction frequency, and transaction duration may be associated with a particular cashier.

The throughput of the cashier may then be characterized 908 using this data. For example, in a plurality of shifts, a maximum transaction frequency achieved by the cashier may be identified. An average of these maximum frequencies may be used to characterize the maximum transaction frequency for the cashier. This maximum transaction frequency may be used as the throughput of that cashier. In some embodiments, details of the transactions processed by the cashier may also be used to characterize a cashier's throughput. For example, the number of items in a transaction may be used as well. In other embodiments, it may be assumed that as long as a large number of transactions are analyzed and the maximum transaction frequency for a plurality of days are averaged, then the number of items in a particular transaction is not important. The throughput of a cashier may be updated periodically to account for increases in expertise. In a like manner, old measurements of a cashier's throughput may be discarded.

The method 900 may further include training 910 a model according to the collected data. For example, data points may be generated using collected data that include a queue length or in-queue time at a specific POS station and one or more factors that may be relevant to queue length or in-queue time, such as a transaction frequency or volume for the entire store at the time of measurement of the queue length or in-queue time, the throughput of the cashier operating a POS at the time of measurement, the total throughput of the cashiers working at the time of measurement, as well as others factors relating to the date and time of measurement, such as day of the week and holidays or other circumstances as described in the methods described above. A delay model may be trained or updated 910 using the collected data and characterizations of cashier throughput as know in the art of data modeling or machine learning using any machine learning algorithm known in the art.

FIG. 10 illustrates a method 1000 that may be used to provide delay estimates using the model and data obtained using the method 900. The method 1000 may include receiving 1002 a request for a delay estimate that include some or all of a time, date, and location. As for other methods described herein, some or all of this information may be inferred. Also, as for other methods, additional data corresponding to the target data may be obtained for use in obtaining a predicted delay.

Staffing for the POS stations 300 of the target location may be retrieved 1004 such as by analyzing electronic work schedules or identifying login of particular cashiers at electronic cash registers of the POS stations 300. The throughput data of the cashiers obtained from the retrieved 1004 staffing data may likewise be retrieved 1006. The throughput data for the cashiers on duty along with the target data may be input to a delay model and used to calculate 1008 a wait time for the target location. In some embodiments, the delay model may relate wait time to a particular cashier or a particular throughput value as trained according to the method 900. Accordingly, for each POS station, a delay value may be calculated by providing as inputs to the delay model the throughput of the cashier at that POS as well as the target data. In some embodiments, the total throughput of cashiers on duty may be used as an input to the delay model even where the output is for a single POS station.

The delays calculated for the location or for individual POS stations 300 may then be returned to a requesting device or user or used in the same manner as delay estimates generated according to other methods described herein. In particular, the delay estimates for each POS station, or each active POS station, of a target location may be returned to a requesting device for display in accordance with the interface illustrated and described with respect to FIG. 4B.

Various uses may be made of delay estimates provided herein. In particular, a user, rather than specify a target date and time, may specify a target time range, that may be several minutes, hours, or days long. The delay estimates for times within the time range, as calculated according to the methods described herein, may be used to determine an advantageous time within the time range to go shopping when the estimated delay is smallest. One or more of the delay estimate for the identified advantageous time and the advantageous time may then be returned to the requesting user. In some embodiments, rather than a shortest delay, those times or time ranges within the specified time range for which the delay is below a user specified threshold or default threshold, as determined according to the methods described herein, may be returned to a requesting user along with delay estimates for these times or time ranges.

In a like manner, a user may provide a target area rather than a target location. A store providing the shortest delay, or below-threshold delay, within the target area and within a specified time range, as predicted by the model, may then be returned to a requesting customer, along with a delay estimate for the identified store and the time at which the delay estimate is shortest for the identified store.

In some embodiments, a delay estimate returned for a target time may include a plurality of data points reflecting delay estimates determined according to methods described herein for a range of times before and/or after the target time. The size of the time range may be a default range or specified by a user. These data points may be plotted on a user computing device 104a, 104b to enable a user to possibly pick a better time than a specified target time to go shopping.

In some embodiments, a user may simply request and receive, for a target location or area, the store and time that will provide the shortest delay, as determined according to methods described herein. Alternatively, a user may request and receive the soonest time, time range, or N time ranges, after a current time for which a delay estimate according to the methods described herein is below some threshold specified by the user or specified by default.

The invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method for delay estimation, the method comprising:
receiving, by a computer system from a user computing device, target data for a target store, the target data including a target date and target time;
calculating, by the computer system, according to the delay model for the target store, a predicted delay for the target data; and
returning, by the computer system, the predicted delay to the user computing device.

2. The method of claim 1, further comprising:
receiving, by the computer system, measured delay data at point of sale (POS) stations of the target store; and
updating the delay model for the target store according to the measured delay data.

3. The method of claim 2, wherein the delay data includes video data imaging the POS stations.

4. The method of claim 3, wherein updating the delay model for the target store according to the measured delay data further comprises:
analyzing the video data imaging the POS stations to identify, for a plurality of dates and times, a number of enqueued individuals at the POS stations; and
updating the delay model according to the identified numbers of enqueued individuals corresponding to the plurality of dates and times.

5. The method of claim 3, wherein updating the delay model for the target store according to the measured delay data further comprises:
analyzing the video data imaging the POS stations to identify a plurality of individuals in the video data; and
for each individual of the plurality of individuals:
determining an in-queue time for the each individual by tracking movement of the each individual in the video data; and
updating the delay model according to the in-queue time for the each individual and a corresponding time and date when the each individual was imaged by the video data.

6. The method of claim 1, further comprising:
receiving, by the computer system, transaction data for transactions conducted at point of sale (POS) stations of the target store; and
updating the delay model for the target store according to the transaction data.

7. The method of claim 6, wherein updating the delay model for the target store according to the transaction data further comprises:
collecting transaction data for POS stations of the target store, the transaction data including identifiers of cashiers working at the POS stations;
calculating for each cashier identifier a throughput of the each cashier according to the collected transaction data; and
updating a transaction volume model according to a frequency of transactions for a given date and time at the target store.

8. The method of claim 7, wherein calculating, by the computer system, according to the delay model for the target store, the predicted delay for the target data further comprises:
retrieving current staffing data for the target store, the current staffing data including a plurality of cashier identifiers;
calculating a predicted transaction volume for the target data using the transaction volume model; and
calculating the predicted delay according to a total throughput for the target store based on the throughputs corresponding to the plurality of cashier identifiers and the predicted transaction volume.

9. A system for delay estimation, the system comprising one or more processors and one or more memory devices operably coupled to the one or more processors, the one or more memory devices storing executable and operational code effective to cause the one or more processors to:
receive from a user computing device, target data for a target store, the target data including a target date and target time;
calculate according to the delay model for the target store, a predicted delay for the target data; and
return the predicted delay to the user computing device.

10. The system of claim 9, wherein the executable and operational data are further effective to cause the one or more processors to:
receive measured delay data at point of sale (POS) stations of the target store; and
update the delay model for the target store according to the measured delay data.

11. The system of claim 10, wherein the delay data includes video data imaging the POS stations.

12. The system of claim 11, wherein the executable and operational data are further effective to cause the one or more processors to update the delay model for the target store according to the measured delay data by:
analyzing the video data imaging the POS stations to identify, for a plurality of dates and times, a number of enqueued individuals at the POS stations; and
updating the delay model according to the identified numbers of enqueued individuals corresponding to the plurality of dates and times.

13. The system of claim 11, wherein the executable and operational data are further effective to cause the one or more processors to update the delay model for the target store according to the measured delay data by:
analyzing the video data imaging the POS stations to identify a plurality of individuals in the video data; and
for each individual of the plurality of individuals:
determining an in-queue time for the each individual by tracking movement of the each individual in the video data; and
updating the delay model according to the in-queue time for the each individual and a corresponding time and date when the each individual was imaged by the video data.

14. The system of claim 9, wherein the executable and operational data are further effective to cause the one or more processors to:
receive transaction data for transactions conducted at point of sale (POS) stations of the target store; and
update the delay model for the target store according to the transaction data.

15. The system of claim 14, wherein the executable and operational data are further effective to cause the one or more processors to update the delay model for the target store according to the transaction data by:
collecting transaction data for POS stations of the target store, the transaction data including identifiers of cashiers working at the POS stations;
calculating for each cashier identifier a throughput of the each cashier according to the collected transaction data; and
updating a transaction volume model according to a frequency of transactions for a given date and time at the target store.

16. The system of claim 15, wherein the executable and operational data are further effective to cause the one or more processors to calculate according to the delay model for the target store the predicted delay for the target data by:
retrieving current staffing data for the target store, the current staffing data including a plurality of cashier identifiers;
calculating a predicted transaction volume for the target data using the transaction volume model; and
calculating the predicted delay according to a total throughput for the target store based on the throughputs corresponding to the plurality of cashier identifiers and the predicted transaction volume.

17. A method for delay estimation, the method comprising:
receiving, by a user computer system, a target time;
transmitting, by the user computer system, the target time and a location to a server system;
receiving, by the user computer system, a delay estimate for the target time for check out at a store associated with the server system that is closest to the location;
displaying, by the user computer system, the delay estimate.

18. The method of claim 17, further comprising obtaining, by the user computer system, the location from a global positioning system receiver of the user computer system.

19. The method of claim 17, further comprising:
receiving, by the user computer system, a date; and
transmitting, by the user computer system, the date to the server system;
wherein the delay estimate corresponds to the date.

20. The method of claim 17, further comprising:
obtaining, by the user computer system, a current date; and
transmitting, by the user computer system, the current date to the server system;
wherein the delay estimate corresponds to the current date.
